(19) United States
(12) Patent Application Publication
(10) Pub. No.: US 2026/0068821 A1
(43) Pub. Date: Mar. 12, 2026

(54) SPROCKET FOR A FEEDERHOUSE OF A COMBINE HARVESTER

(71) Applicant: AGCO do Brasil Soluções Agrícolas Ltda., Jundiaí (BR)

(72) Inventors: Airton Solimar Walter, Canoas (BR); Ariel Abling, Canoas (BR); Lauro Bonetti, Canoas (BR)

(21) Appl. No.: 19/321,659

(22) Filed: Sep. 8, 2025

(30) Foreign Application Priority Data
Sep. 9, 2024 (GB) 2413225.0

(51) Int. Cl. A01D 69/06; A01D 41/06; A01D 61/02; A01F 12/10

(52) U.S. Cl. CPC A01D 69/06; A01D 41/06; A01D 61/02; A01F 12/10

(57) ABSTRACT

A drive sprocket is provided for the belt of a feederhouse of a combine harvester. The sprocket design reduces the trapping of plant material, by the particular shape features of a central hub, drive pins and connecting webs that couple the drive pins to the central hub.

### FIELD

Embodiments of the present disclosure relate generally to combine harvesters, and in particular to the feederhouse used to deliver crop material to the threshing system of the combine harvester, and more particularly to the sprockets used to drive a belt of the feederhouse.

### BACKGROUND

A combine harvester typically includes a crop cutting head and a threshing system for detaching grains of cereal from the ears of cereal. A delivery system delivers the cut crop to the threshing system, known as the feederhouse. A separating apparatus is downstream of the threshing system, and a grain cleaning apparatus receives grain from the separating apparatus. A stratification pan aims to stratify the material into a layered structure of grain at the bottom and light chaff and other material other than grain (MOG) at the top.

The feederhouse is typically in the form of a conveyor chain or belt with cross bars that transport the crop material.

There are various designs for the threshing system and for the separating apparatus (e.g. axial or transverse) as well as for the grain cleaning apparatus. However, in all designs, there is a flow of material from the threshing system to the separating apparatus, and between the separating apparatus and the grain cleaning unit.

The feederhouse is one of the limiting performance factors of modern large combines and there is therefore a continuing need for an improved feederhouse design.

Typically, within a feederhouse, a toothed or cogged belt is driven by sprockets. For example, a toothed belt is typically driven by sprockets mounted on rotating drive shafts. Each sprocket comprises projecting pins that engage with recesses formed on the underside of the toothed belts.

There is an issue that plant material such as cobs can become lodged in the sprocket, affecting the drive of the feederhouse. For example, plant material can become lodged between the pins or between the pins and a central hub.

This issue has for example been recognized in EP3289854, which discloses a sprocket for a feederhouse having a hub with drive pins distributed around the hub. The hub is attached to an end face and the pins extend from the end face. Connecting webs extend between each of the pins and an inclined surface of the hub. The pins have a tapered section, tapering inwardly towards an open end of the sprocket. The inclined hub surface helps prevent corn from becoming trapped in the sprocket. In addition, a clearing out member is provided to dislodge any cobs that have been caught between the connecting walls or between the hub or drive shaft and the pins, as the drive shaft rotates.

However, the trapping of material in the drive sprocket does still arise in existing systems, and there is a need for an improved sprocket design.

### BRIEF SUMMARY

The invention is defined by the claims. According to examples in accordance with this disclosure, there is provided a sprocket for a feederhouse of a combine harvester having an annular arrangement of drive pins around a central hub, an annular support disc extending from the central hub, wherein the drive pins are connected at an outer edge of the annular support disc, wherein a first set of the annular arrangement of drive pins extends away from the support disc in a first axial direction to define a first end of the sprocket and a second set of the annular arrangement of drive pins extends away from the support disc in a second axial direction, opposed to the first axial direction, to define a second end of the sprocket, on each side of the support disc a support web extending radially between each drive pin and the central hub, each support web projecting outwardly from the central hub to an associated drive pin and each support web curving from a first position adjacent the central hub to a second position adjacent the drive pin and which is closer to the respective first or second end of the sprocket.

Preferably each support web projects normally or in a direction towards the respective first or second end of the sprocket, at an angle (Θ) in the range of 80 degrees to 90 degrees, and the curve of each support web has a radius of curvature in the range of 30 mm to 40 mm.

This sprocket design has a support web which extends steeply from the central hub, with a large radius of curvature (relative to the size of a cob). These design details reduce the incidence of cobs being trapped in the sprocket.

The support disc for example tapers inwardly from central hub towards the drive pins. Thus, it encourages material to flow radially outwardly so that it is less likely to become lodged. It can then escape from the space between the central hub and the drive pins, for example, by the support webs. The angle of taper is for example in the range 8 to 15 degrees.

The central hub for example has a first end and a second end, and the first position (wherein the web connects to the hub) is set back from the outer end (of the central hub) by a spacing in the range 15 mm to 25 mm. Thus, the radially inner end of the web is set only a shallow amount behind the outer end of the central hub.

The second position is for example set back from the free end of the drive pin by a spacing in the range 5 mm to 12 mm. Thus, the radially outer end of the web is also set only a shallow amount behind the outer end of the sprocket (i.e., the ends of the drive pins).

A plurality of the drive pins have a semi-circular cross-sectional shape between the annular support disc and either the first end or the second end of the sprocket, with a curved portion of the semi-circular cross-sectional shape facing radially outwardly. This semi-circular shape engages grooves in the drive belt. It means a small amount of material is used to form the drive pins, while fully engaging with the grooves in the drive belt.

The central hub for example has an inner end and an outer end and wherein the inner end of the central hub is spaced from the first end by a spacing in the range 8 mm to 15 mm. The outer end of the central hub is for example spaced from the outer end of the sprocket by a spacing in the range 8 mm to 15 mm.

Preferably, a sprocket assembly comprises a base plate and sprocket of the kind set forth in which a sub-set of the drive pins is for example connected to the base plate at the first end of the sprocket. For example, the base plate is bolted to the sub-set of the drive pins.

The drive pins of the sub-set for example have a circular cross section between the first end and the support disc. This provides a better coupling between the sub-set of the drive pins and the base plate. The sub-set of drive pins for example comprises three drive pins.

This disclosure also provides a feederhouse having at least one belt, at least a first sprocket or first sprocket assembly as defined above non rotatably mounted on a first shaft at a first end of the belt, a second sprocket or pulley non rotatably mounted on a second shaft at a second, opposite, end of the belt. The feederhouse may further comprise a tensioning system for tensioning the belt.

This disclosure also provides a combine harvester having a crop cutting head, the feederhouse as defined above, a threshing system, a separating system, and a grain cleaning system for receiving the cut and threshed crop material.

### BRIEF DESCRIPTION OF THE DRAWINGS

One or more embodiments of this disclosure will now be described, by way of example only, with reference to the accompanying drawings, in which:

FIG. 1 shows a combine harvester which may be adapted in accordance with this disclosure;

FIG. 2 shows one example of threshing system and grain cleaning apparatus in more detail;

FIG. 3 shows an exploded view of a sprocket assembly for a feederhouse of a combine harvester;

FIG. 4 shows an assembled sprocket assembly and the arrangement of drive pins;

FIG. 5 shows the arrangement of drive pins of a sprocket viewed from a second end in perspective view;

FIG. 6 shows the arrangement of drive pins of the sprocket viewed from the second end in end view;

FIG. 7 shows the arrangement of drive pins of the sprocket viewed from the first end in perspective view;

FIG. 8 shows the arrangement of drive pins of the sprocketviewed from the first end in end view;

FIG. 9 shows a cross section through the arrangement of drive pins of the sprocket, taken through the rotation axis of the central hub;

FIG. 10 shows a cross section through the arrangement of drive pins of the sprocket, taken parallel to, but offset from, the rotation axis of the central hub;

FIG. 11 shows the cross section of FIG. 9 with added dimensions;

FIG. 12 shows an enlarged view of a cross section through a drive pin which has a semi-circular cross section at both ends;

FIG. 13 shows the drive pin cross sections more clearly; and

FIG. 14 shows more clearly the shape of the support disc.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure relates to the design of a drive sprocket for the belt of a feederhouse of a combine harvester. The feederhouse is for delivering crop material to the threshing system of a combine harvester. In particular, this disclosure relates to a sprocket design which reduces the trapping of plant material, by the particular shape features of a central hub, drive pins and connecting webs that couple the drive pins to the central hub.

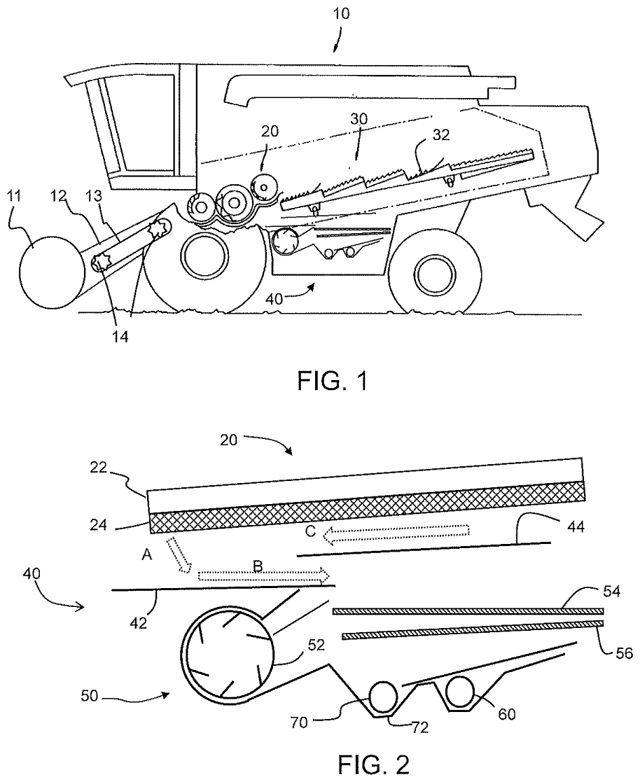

FIG. 1 shows a known combine harvester 10 to which the teachings of this disclosure may be applied. A crop cutting head 11 (known as the header) for example comprises a wide laterally extending transverse auger, which cuts the crop material and drives it inwardly towards a central area. A front elevator housing 12 receives the cut crop material and includes a feederhouse for transporting the crop material.

The feederhouse comprises a plurality of belts 13 (seen in side view in FIG. 1) driven around axles 14. An upper axle is provided with a plurality of sprockets provided with circumferentially spaced drive pins. The drive pins engage with gaps between teeth along the inner surface of the belt. A lower axle may be provided wit h similar sprockets or, alternatively, pulleys about which the belt travels.

The feederhouse delivers the crop material to a threshing system 20 for detaching grains of cereal from the ears of cereal, and a separating apparatus 30 which is connected downstream of the threshing system 20. The threshing system comprises one or more threshing units, in particular rotors, and associated concaves.

In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

In the example shown, the threshing system 20 is a tangential-flow ‘conventional’ threshing system, i.e. formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e. formed by rotating elements with an axis of rotation in the longitudinal direction (direction of travel). For example, the threshing section may have axially-aligned rasp bars spaced around the front section whilst the separating section has separating elements or fingers arranged in a pattern, e.g. a spiral pattern, extending from the rasp bars to the rear of the rotor.

By way of example, an axial threshing (and separating) system 20 is shown in FIG. 2, together with a cleaning apparatus 40.

The threshing system 20 comprises an axial rotor 22 beneath which is mounted the concave 24. The concave may have different sections along its length. The separating function involves conveying the crop stream rearwardly in a ribbon passing along a spiral path.

The initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 does not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 removes this unwanted material thus leaving a clean sample of grain to be delivered to the tank.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to this disclosure. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56 which removes tailings from the stream of grain before being conveyed to on-board tank (not shown) by grain collecting auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner.

This disclosure relates to the design of the feederhouse for delivering crop material to the threshing and separating systems. It may be used in a conventional (transverse) machine, an axial machine, or a hybrid machine (with transverse threshing and axial separation). In particular, this disclosure relates to the drive sprockets around which the feederhouse belt is mounted at opposite ends of the feederhouse belt.

The belt is preferably hydraulically driven, although it may be electrically driven. A belt tensioning system is used to maintain belt tension, for example a spring-based tensioning unit. In known manner, belt tensioning may be entirely manual, or the belt tension may be electronically monitored and then manually adjusted, or it may be electronically monitored and then automatically hydraulically or electrically adjusted (from the cab).

The belt is for example rubber, such as a rubber matting onto which lateral gripping bars (or recesses) are provided and optionally also longitudinal guiding bars (or recesses).

For example, the belt may be as shown in EP 3 289 854. Two belts are spaced apart with connecting gripping bars between them on the outer surface of the two belts. Each belt is driven around a pair of sprockets. The inner surfaces of each belt has a row of teeth. Drive pins of the sprocket fit in the spaces between adjacent teeth.

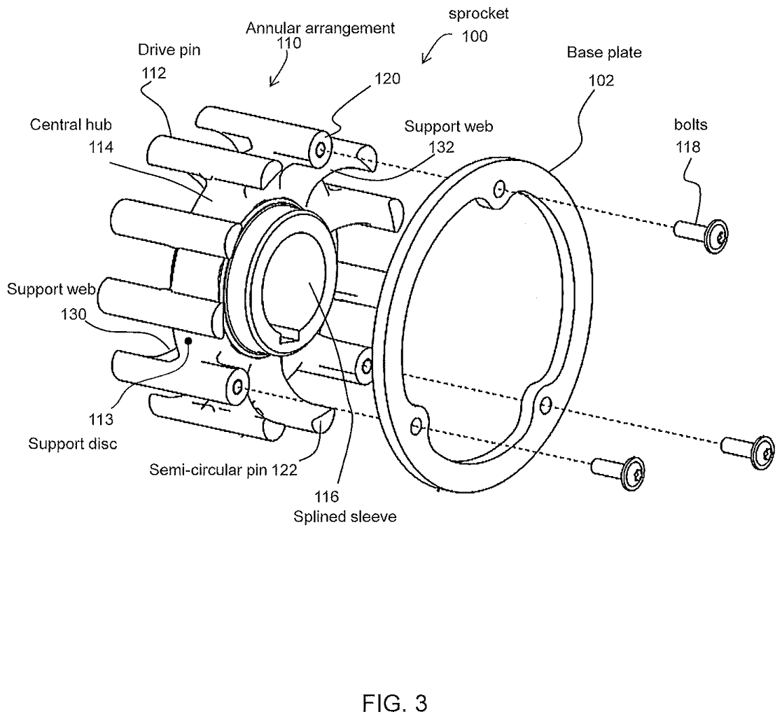

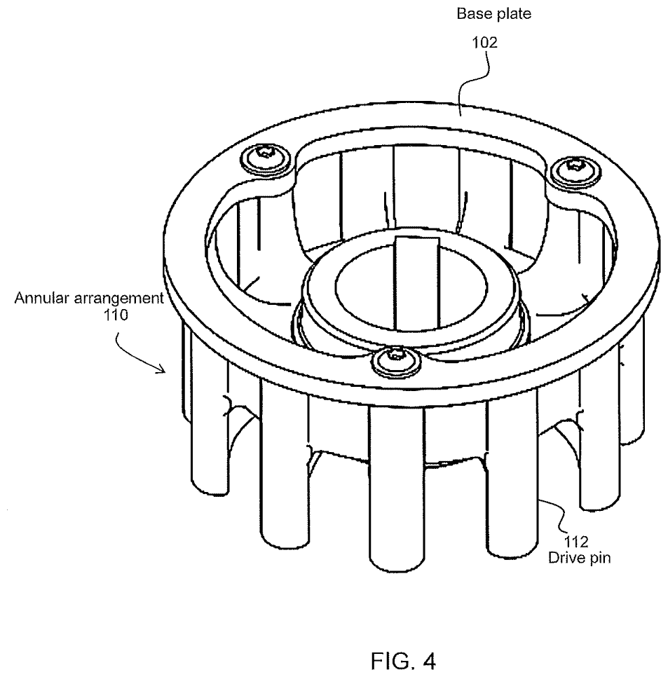

FIG. 3 shows an exploded view of a sprocket assembly for a feederhouse of a combine harvester. The sprocket assembly comprises a sprocket 100 and a base plate 102 which is circular (in the example shown it is a circular annulus) or at least has a circular portion. An annular arrangement 110 of drive pins 112 is formed around a central hub 114. The inner surface of the central hub is formed by a splined sleeve 116.

The drive pins 112 are connected at the outer edge of an annular support disc 113.

It is noted that the different parts of the annular arrangement (i.e. the drive pins, the central hub and the webs) are described as separate entities. This is only for the purposes of explaining the shape features. In practice, these parts all form a single homogeneous body, such as a cast metal component.

The annular arrangement 110 of drive pins 112 may be connected to the base plate 102 by suitable fasteners, for example bolts 118. In the example shown, there are three bolts, and they connect to the ends of three of the drive pins 112, arranged as an equilateral triangle. FIG. 3 shows the base plate and arrangement of drive pins in exploded view.

The drive pins extend from a first end of the sprocket to a second end of the sprocket such that to each side of the support disc 113 the free ends define an outer end of the sprocket.

The outer surface of the drive pins engages with an inner surface of the drive belt, and the drive belt has recesses corresponding in shape to the radially outer shape of the drive pins. This radially outer shape is arcuate, and a plurality of the drive pins generally have a semi-circular cross-sectional shape 122 along their length, with the arcuate portion facing outwardly. However, to provide a secure connection point, a first sub-set of drive pins, the drive pins that connect to the base plate have a circular cross section 120 between the annular support disc 113 and first end of the sprocket 100.

A support web extends radially between each drive pin and the central hub on each side of the support web 113. A first support web 130 is at the second end side of the central hub and a second support web 132 is at the first end of the central hub.

FIG. 4 shows the assembled sprocket assembly and the arrangement 110 of the drive pins 112.

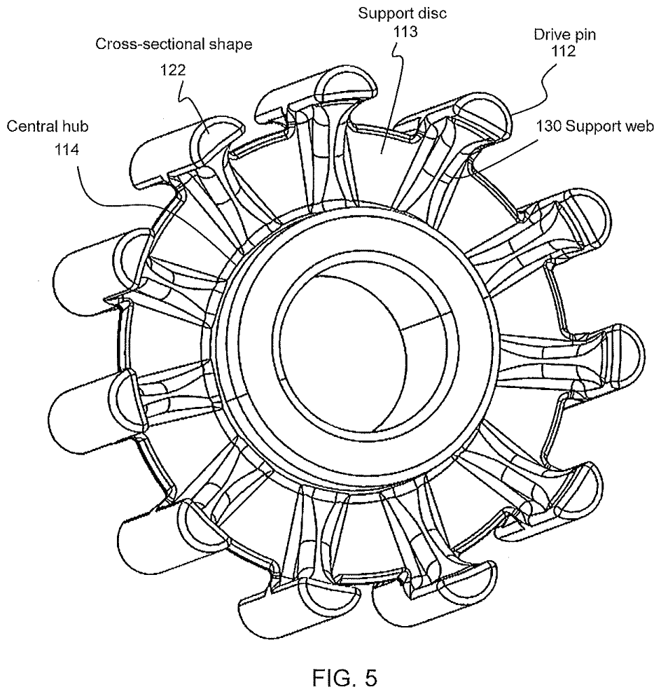

FIG. 5 shows the arrangement of drive pins 112 of the sprocket 100 viewed from the free end in perspective view. The spline slot is not shown in FIGS. 5 to 11.

As shown, at the second end of the sprocket, all of the drive pins have a semi-circular cross-sectional shape 122. From this viewpoint, the first support webs 130 can be seen more clearly, namely those at the second end side of the support disc 113.

Each support web 130 at the second end side of the support disc curves from a first position adjacent the hub 114 to a second position adjacent the drive pin 112. The second position is closer to the outer end of the sprocket.

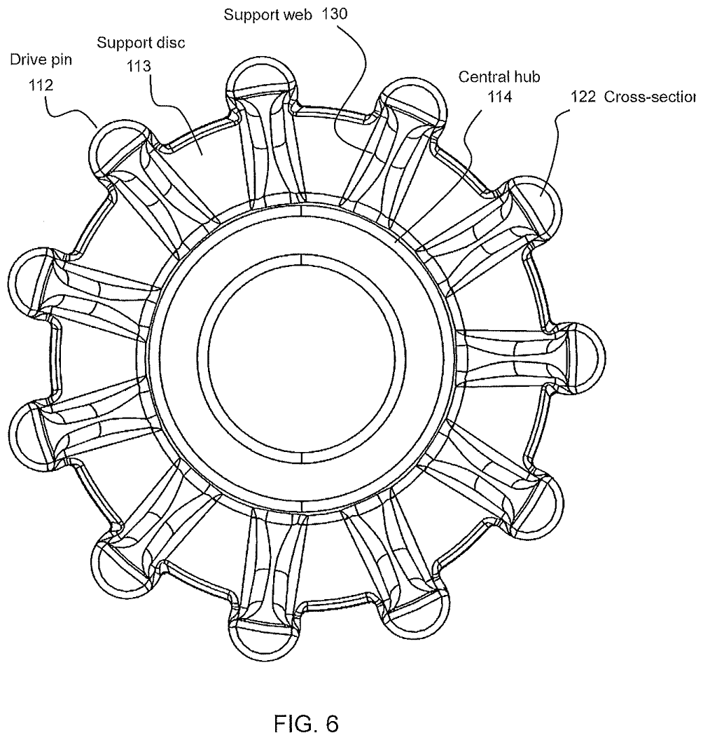

FIG. 6 shows the arrangement of drive pins 112 of FIG. 5 viewed from the second end in end view.

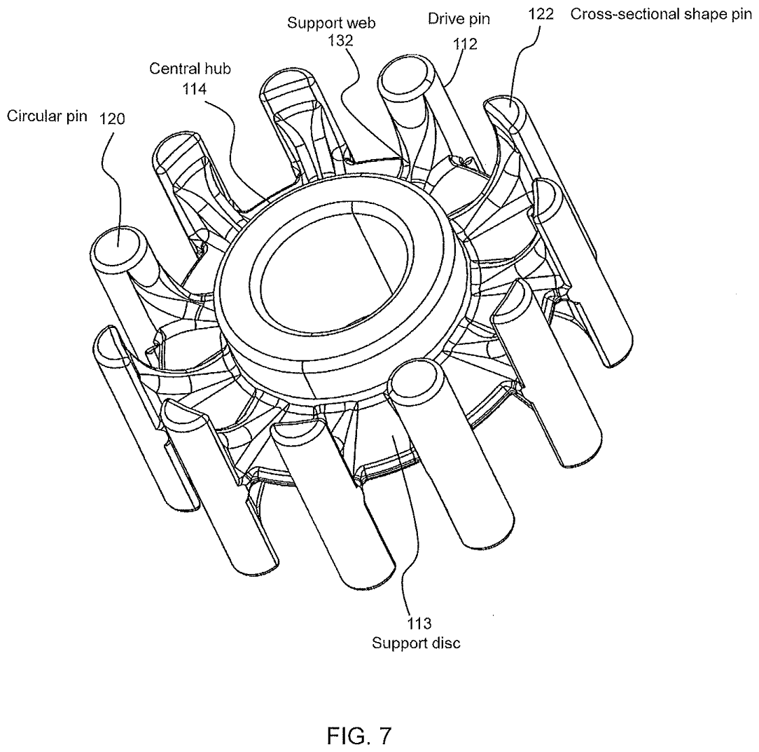

FIG. 7 shows the arrangement of drive pins 112 viewed from the first end in perspective view. The spline slot is again not shown, and the support disc is not present.

As shown, at the first end, three of the drive pins have the circular cross-sectional shape 120. Those drive pins have a section with a semi-circular cross section at the second end side of the support web 113 and a circular cross section at the first end side of the support web 113. From this viewpoint, the second support webs 132 can be seen more clearly, namely those at the first end side of the support disc 113.

It will be understood that each of the drive pins 112 presents at least a semicircular profile along its length to the underside of the toothed or cogged belt. This has as an advantage that the drive pins provide a more uniform contact to engage the toothed or cogged belt than the arrangement shown in EP328985.

Each support web 132 at the first side of the support disc 113 also curves from a first position adjacent the hub 114 to a second position adjacent the drive pin 112 and which is closer to the first end of the sprocket.

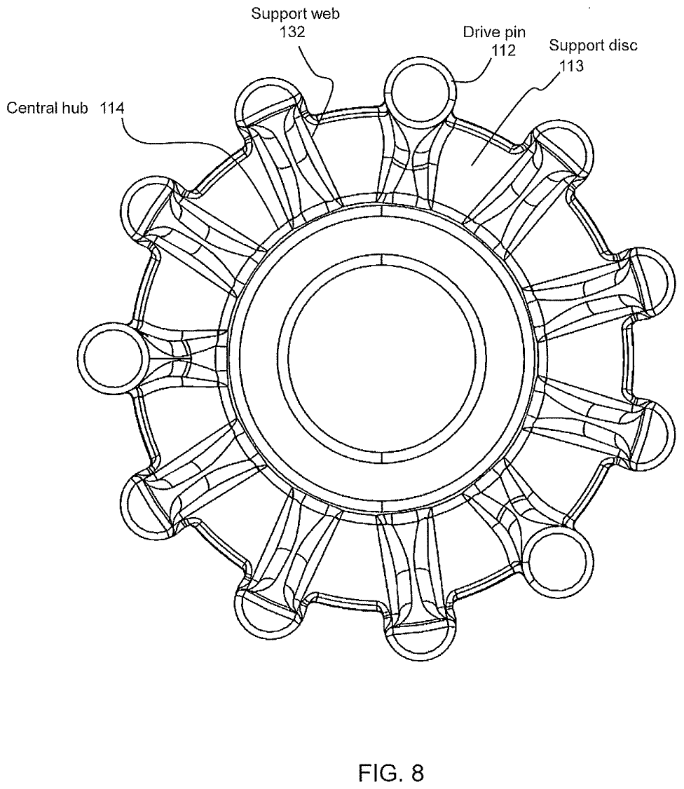

FIG. 8 shows the arrangement of drive pins of FIG. 7 viewed from the first end in end view.

FIG. 9 shows a cross section through the arrangement of drive pins, taken through the rotation axis of the central hub, and passing through the center of one of the three drive pins having a circular cross section at the first end. There are 11 drive pins evenly distributed around the hub 114, so the cross section passes through a drive pin at one side and through the support disc 113 (between adjacent drive pins) at the other side.

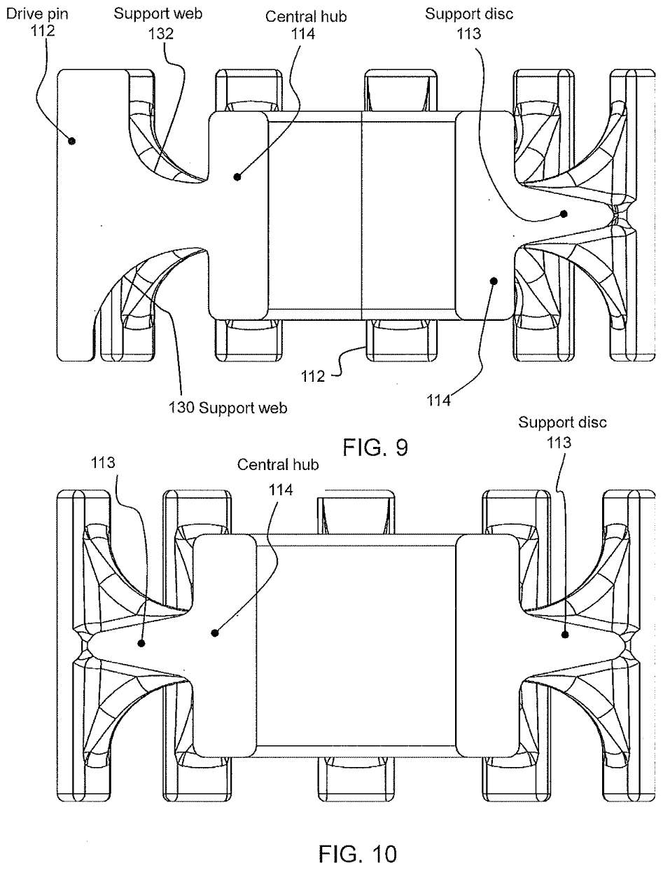

FIG. 10 shows a cross section through the arrangement of drive pins, taken parallel to, but offset from, the rotation axis of the central hub, so that it passes the support disc 113 at both sides. It shows that in this example the support web 113 and the central hub are symmetrical between the base plate side and free end side.

This disclosure relates in particular to the geometric design of the arrangement of drive pins, in particular the support webs 130 and support disc 113. Dimensions will now be shown for one particular design. However, deviations may be made to the specific dimensions shown, and suitable ranges are provided.

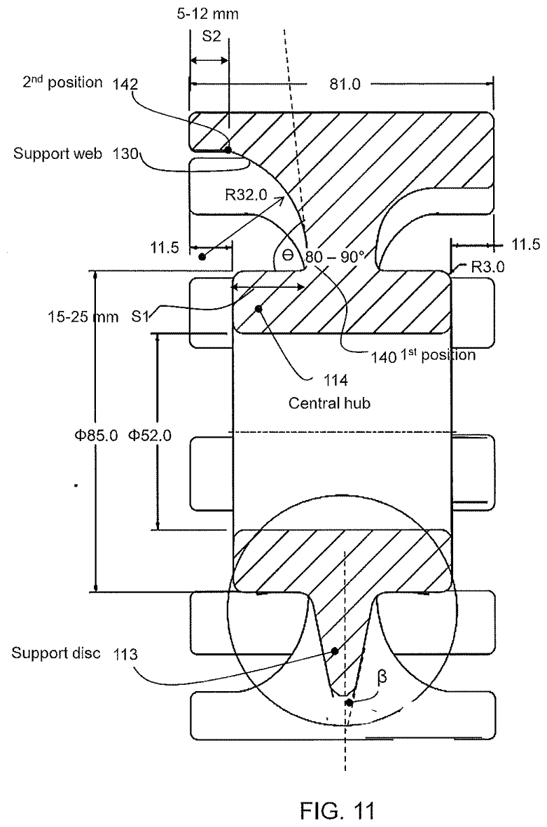

### FIG. 11 shows the cross section of FIG. 9 with added dimensions.

The support web 130 on the second end side projects outwardly from the central hub 114 to an associated drive pin, normally or in a direction towards the outer end of the sprocket, at an angle Θ. The angle is in the range 80 degrees to 90 degrees. In the particular examples it is 88 degrees.

The support web 130 curves from a first position 140 adjacent the hub 114 to a second position 142 adjacent the drive pin 112. The second position is closer to the outer end of the sprocket, i.e., the web curves towards the end of the drive pin. The curve has a radius of curvature in the range 30 mm to 40 mm, such as 32.0 mm as shown for this particular design example.

The support web 132 on the base plate side also projects outwardly from the central hub 114 to an associated drive pin, normally or in a direction towards the outer end of the sprocket, at an angle which is also in the range 80 degrees to 90 degrees.

This sprocket design has a support web which extends steeply from the central hub, with a large radius of curvature (relative to the size of a cob). These design details, in combination, reduce the incidence of cobs being trapped in the sprocket.

FIG. 11 also shows that the support disc 113 tapers inwardly from the central hub towards the drive pins or towards its outer edge (between the drive pins). Thus, it encourages material to flow radially outwardly so that it is less likely to become lodged. It can then escape from the space between the central hub and the drive pins, for example, by the support webs. The angle of taper β is for example in the range 8 to 15 degrees.

The inner diameter of the hub in this example is 52 mm (e.g. 40 mm to 65 mm) and the outer diameter is 85 mm (e.g. 70 mm to 100 mm), so that the radial thickness of the central hub in the particular example shown is 17.5 mm ((85−52)/2). The drive pins extend, in the length direction of the drive pins, beyond both ends of the central hub 114 by amount in the range 8 mm to 15 mm, such as 11.5 mm as shown. These two dimensions may be the same (as shown) or different.

The first position 140 (wherein the web 130 connects to the hub) is set back from the outer end (of the central hub) by a spacing S1 in the range 15 mm to 25 mm, for example 18.7 mm. Thus, the radially inner end of the web is set only a shallow amount behind the outer end of the central hub.

The second position 142 is for example set back from the free end of the drive pin by a spacing S2 in the range 5 mm to 12 mm, for example 8.8 mm. Thus, the radially outer end of the web 130 is also set only a shallow amount behind the outer end of the sprocket (i.e., the ends of the drive pins).

The length of the drive pins is 81.0 mm (for example 50 mm to 150 mm) and the length of the hub is 58 mm in this example (81−2*11.5), for example 40 mm to 100 mm.

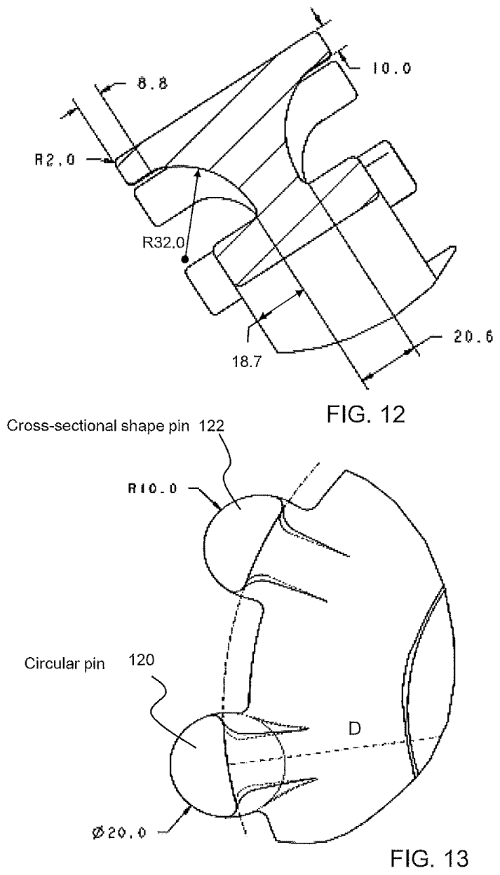

FIG. 12 shows an enlarged view of a cross section through a drive pin which has a semi-circular cross section at both ends. It shows that the semi-circular shape has a radius of 10 mm, and it shows the example of S1=18.7 mm and S2=8.8 mm. Furthermore, it shows that the arrangement is symmetrical between the first side and the second side for the pins which do not change their cross-sectional shape. Thus, the webs 130 and 132 are identical for those drive pins.

FIG. 13 shows the 10 mm radius of a semi-circular drive pin cross section 122 and the 20 mm diameter of the circular drive pin cross section 120. More generally, the 10 mm radius may be in the range 8 mm to 20 mm. It is chosen to match the belt to be driven. FIG. 13 shows that the outer edge of the support disc 113 ends just before the centers of the drive pins. The total diameter D, to the center of the drive pins, is in this example 149.0 mm

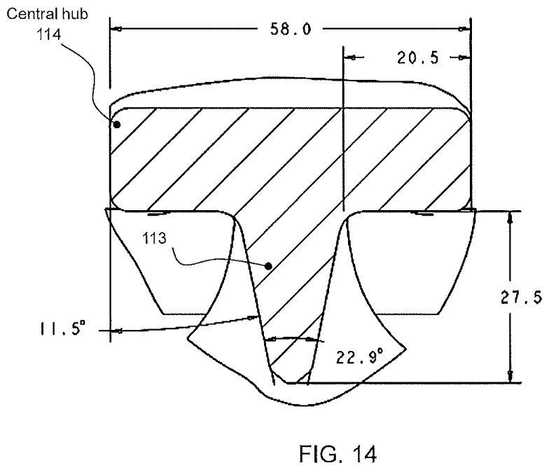

FIG. 14 shows the shape of the support disc 113. The angle of taper β is shown as 11.5 degrees. The support disc 113 has a maximum width (in the length direction of the drive pins) of 17.0 mm (58−2*20.5) such as 12 mm to 30 mm. The radial spacing between the central hub 114 and the radially outer edge of the support disc is in this example 27.5 mm.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a”or “an”does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

What is claimed is:

1. A sprocket for a feederhouse of a combine harvester, comprising:
an annular arrangement of drive pins around a central hub, an annular support disc extending from the central hub, the drive pins being connected at the outer edge of an annular support disc, a first set of the annular arrangement of drive pins extending away from the support disc in a first axial direction to define a first end of the sprocket and a second set of the annular arrangement of drive pins extending away from the support disc in a second axial direction, opposed to the first axial direction, to define a second end of the sprocket; and
on each side of the support disc a support web extending radially between each drive pin and the central hub, each support web projecting outwardly from the central hub to an associated drive pin and each support web curving from a first position adjacent the central hub to a second position adjacent the drive pin and which is closer to the respective first or second end of the sprocket.

2. The sprocket of claim 1, wherein each support web projects normally or in a direction towards the respective first or second end of the sprocket, at an angle (Θ) in the range 80 degrees to 90 degrees, and wherein the curve of each support web has a radius of curvature in the range 30 mm to 40 mm.

3. The sprocket of claim 1, wherein the support disc tapers inwardly from the central hub towards the drive pins.

4. The sprocket of claim 3, wherein the angle of taper (β) is in the range 8 to 15 degrees.

5. The sprocket of claim 1, wherein the central hub has a first end and a second end, and the first position is set back from the second end by a spacing in the range 15 mm to 25 mm.

6. The sprocket of claim 1, wherein the second position is set back from the end of the drive pin by a spacing in the range 5 mm to 12 mm.

7. The sprocket of any one of claim 1, wherein a plurality of the drive pins have a semi-circular cross-sectional shape between the annular support disc and either the first end or the second end of the sprocket, with a curved portion of the semi-circular cross-sectional shape facing radially outwardly.

8. The sprocket of claim 7, wherein the drive pins of the sub-set have a circular cross section between the annular support disc and the first end.

9. The sprocket of claim 8, wherein the sub-set of drive pins comprises three drive pins.

10. The sprocket of claim 1, wherein the central hub has a first end and an outer end and wherein the first end of the central hub is spaced from the base plate by a spacing in the range 8 mm to 15 mm.

11. The sprocket of claim 1, wherein the central hub has a first end and an outer end and wherein the outer end of the central hub is spaced from the outer end of the sprocket by a spacing in the range 8 mm to 15 mm.

12. A sprocket assembly comprising a sprocket according to claim 1 and a base plate, wherein a sub-set of the drive pins is connected to the base plate.

13. A feederhouse comprising:
a belt;
a sprocket assembly according to claim 12 at a first end of the belt;
a second sprocket or pulley at a second, opposite, end of the belt.

13. A combine harvester comprising:
a crop cutting head;
the feederhouse of claim 13;
a threshing system;
a separating system; and
a grain cleaning system for receiving the cut and threshed crop material.
